(19) United States
(12) Patent Application Publication
(10) Pub. No.: US 2013/0219967 A1
(43) Pub. Date: Aug. 29, 2013

(54) METHOD AND DEVICE FOR PRODUCING POLYCRYSTALLINE SILICON BLOCKS

(71) Applicants: Stephan Hussy, Nurnberg (DE); Christian Hoess, Munchen (DE)

(72) Inventors: Stephan Hussy, Nurnberg (DE); Christian Hoess, Munchen (DE)

(73) Assignee: CENTROTHERM SITEC GMBH, Blaubeuren (DE)

(21) Appl. No.: 13/703,922

(22) PCT Filed: Jun. 10, 2011
(86) PCT No.: PCT/EP2011/002858

§ 371 Date: May 7, 2013

(30) Foreign Application Priority Data
Jun. 16, 2010 (DE) 10 2010 024 010.9

(51) Int. Cl. F27B 14/04; C01B 33/021

(52) U.S. Cl. CPC F27B 14/04; C01B 33/021
USPC 65/90; 65/157

(57) ABSTRACT

A crucible is filled with silicon material and is arranged in a process chamber. The silicon material in the crucible is melted and is subsequently cooled below the solidification temperature. During a time period, a plate element that has at least one passage may be arranged over the molten silicon in the crucible, and a gas flow may be directed onto the surface of the molten silicon at least partially via the at least one passage. Alternatively a crucible arrangement includes a crucible and a holding ring arranged on or above a crucible filled with silicon material. Additional silicon material may be received and held above the crucible by the holding ring. During the heating of the silicon material in the crucible and the holding ring, molten silicon is formed in a crucible, which is subsequently cooled below the solidification temperature of the silicon.

### RELATED APPLICATION

This application corresponds to PCT/EP2011/002858, filed Jun. 10, 2011, which claims the benefit of German Application No. 10 2010 024 010.9, filed Jun. 16, 2010, the subject matter of which is incorporated herein by reference in its entirety.

### FIELD OF THE INVENTION

The present invention relates to a process and an apparatus for producing polycrystalline silicon ingots.

### BACKGROUND OF THE INVENTION

In the arts of semi-conductors and solar cells, it is known to manufacture polycrystalline silicon ingots by melting high purity silicon material in a melting vessel or crucible. As an example, DE 199 34 940 C2 describes a corresponding apparatus for this purpose. The apparatus generally consists of an isolated box having interior heating elements, a crucible, and a recharging unit located in the isolated box.

During manufacturing of the silicon ingot, the crucible is loaded with granulated silicon to its maximum filling height, while the isolated box is open. The isolated box is subsequently closed and the granulated silicon is melted in the crucible by the heating elements. Upon loading the crucible with granulated material, air pockets are generated, such that the filling height of the molten silicon in the crucible is substantially lower than the filling height of the granulated silicon. Since a crucible may typically be used only once, a recharging unit is provided in the apparatus mentioned above, which recharging unit is adapted to charge dried, free flowing silicon material into the molten silicon in the crucible, in order to increase the filling height.

When the desired filling height of the molten silicon in the crucible is reached, the molten silicon is then cooled down in a controlled manner in order to provide a directional solidification. During this directional solidification the type of cooling and the atmosphere have a substantial influence on the size and orientation of the crystallites generated during the directional solidification. The above cited apparatus only provides a few possibilities to influence the cooling and the atmosphere. Furthermore, the recharging unit in the above cited apparatus is complicated. The production of dried, free-flowing silicon material is difficult and involves high cost. For the production, typically silicon rods, which are for example produced by the Siemens method, are mechanically broken. It is known that the silicon rods are for example, broken with hammers, chisels, or grinders in order obtain broken silicon. The broken silicon pieces are typically etched in a HF/HNO₃ mixture, thereby removing a portion of the surface (typically 20 μm) of the silicon pieces. The smaller the free-flowing silicon material, the larger the loss of material. The reason for etching is a cleaning of the broken-up pieces and in particular, a removal of contaminations of the surface which may be caused by the tools used for breaking up the silicon. The etching also removes silicon oxide from the silicon surface. In particular metallic contaminations which are caused by the used tools such as iron, chrome, nickel, and copper have to be removed from the broken up silicon pieces. Furthermore, other contaminations which may be caused by the surrounding atmosphere (air, oxygen, dust, and particles in the air), may be removed. Such contaminations may be inter alia native oxides. The removal surface of each broken up piece is typically at least 7.5 μm. Subsequently, the broken up pieces are typically rinsed with deionised water then dried in a cleaned gas-flow (N₂-flow).

Starting from the known apparatus, the problem to be solved by the invention is, to provide an apparatus and a process for manufacturing polycrystalline silicon ingots, which allow the process to be controlled more flexibly. It is a further object of the invention to provide a desired filling height of molten silicon in a crucible during the production of polycrystalline silicon ingots in an easy and inexpensive manner.

### SUMMARY OF THE INVENTION

According to the invention, a process for producing a polycrystalline silicon ingot, according to claim 1, and an apparatus for producing a polycrystalline silicon ingot, according to claim 4 are provided. Other embodiments of the invention may be derived from the dependent claims.

During the method, a crucible is positioned in a process chamber, wherein the crucible is preloaded with solid silicon material or the solid silicon material is loaded into the crucible in the process chamber.

Subsequently, the silicon material in the crucible is heated above its melting temperature while the process chamber is kept closed, which then produces molten silicon in the crucible. Afterwards, the molten silicon in the crucible is cooled below its solidification temperature. A plate element, which is located in the process chamber and comprises at least one passage for introducing a gas, is lowered above the crucible. During at least one time period during the time of solidification of the molten silicon, a gas flow is directed onto the surface of the molten silicon, wherein the gas flow is directed at least partially via the at least one passage in the plate element onto the surface of the molten silicon. Indeed, the gas flow may, in addition, also be directed onto the surface of the silicon located in the crucible during the heating and/or cooling process. Directing the gas onto the surface of the molten silicon in the space formed between the surface and the plate element allows for a good adjustability of the cooling parameters and also allows for a good adjustability of the atmosphere at the surface of the molten material. The term time period of solidification of the molten silicon means the time period during which a phase change of the silicon from liquid phase to solid phase occurs. Prior to closing the process chamber, additional silicon material is mounted to the plate element such that during the lowering of the plate element at least a portion of the additional silicon material is dipped into the molten silicon in the crucible and melts, thus increasing the level of molten silicon in the crucible. Thus the plate element acts both as a gas feed element and a recharging unit.

The additional silicon material is preferably in the shape of at least one of silicon rods and silicon discs, which facilitates processing thereof. Furthermore, due to the size of such material it is easy to mount to the plate element.

For a good adjustability of the filling height of the silicon material in the crucible, the amount of solid silicon material in the crucible and the amount of additional silicon material are matched to each other. This may be done via the weight of the material.

The apparatus, according to the invention, comprises: a process chamber having a crucible holder for receiving a crucible, a plate element arranged in the process chamber above the crucible holder, the plate element comprising at least one passage for a gas feed, optionally a lifting mechanism, at least one gas feeding tube extending in or through the at least one passage in the plate element, and at least one gas feeding unit located outside of the process chamber for feeding a gas flow into and through the gas feeding tube to a region below the plate element. The plate element comprises means for mounting or holding silicon material in order to be able to act as a charging unit. In particular, the additional silicon material may be introduced into the molten silicon only by moving the plate element, such that no additional guiding elements are necessary. Such an apparatus has the advantages already discussed above with respect to the method.

The apparatus may also comprise a holding ring arranged in the process chamber, the holding ring having internal dimensions corresponding to the internal dimensions of the crucible as well as an optional lifting mechanism for the holding ring. The holding ring is capable of holding silicon material above the crucible prior to melting the silicon material to thereby improve the filling height of the molten silicon in the crucible during the process. The optional lifting unit enables lifting the holding ring off the crucible after melting the silicon material during the process, such that the holding ring does not influence the process in a negative manner. Preferably, the holding ring is made of silicon nitride or at least has a silicon nitride coating on the inner circumference thereof.

In accordance with one embodiment of the invention, at least one side heater located laterally with respect to the crucible holder, at least one gas outlet and at least one foil curtain are provided, wherein the at least one foil curtain is provided between the at least one side heater and the crucible, in such a way that a gas flow from the at least one gas feeding tube is guided towards the at least one gas outlet without flowing along the at least one side heater. Thus, a gas flow which is guided over the surface of the molten silicon and after contacting the same may be guided along the surface of the foil curtain facing the crucible towards the gas outlet such that the gas flow does not come into the region of the side heater. Such a foil curtain protects the side heater against gases from the process space (such as gaseous silicon stemming from the molten silicon) directly contacting the side heater which could cover or destroy the same over time. The foil curtain is preferably heat resistant and impermeable to gas and is furthermore mounted in the process chamber in a manner that enables easy replacement thereof. As soon as the foil curtain has a reduced functionality after several process cycles due to the strain induced by the process, it may be easily replaced.

The plate element may also be formed as a heating device or may support a heating device.

### BRIEF DESCRIPTION OF THE DRAWINGS

The invention will be described herein below with reference to the drawings; in the drawings:

FIG. 1 is a schematic sectional view of an apparatus for producing a polycrystalline silicon ingot, showing a crucible filled with silicon raw material;

FIG. 2 is a schematic view similar to FIG. 1, wherein the silicon raw material in the crucible is molten;

FIG. 3 is a schematic view similar to FIG. 2, wherein additional silicon raw material is immersed into the crucible;

FIG. 4 is a schematic view similar to FIG. 3 during a cooling phase;

FIG. 5 is a schematic view of an alternative apparatus for producing a polycrystalline silicon ingot showing a silicon crucible filled with silicon raw material;

FIG. 6 is a schematic view similar to FIG. 5, wherein the silicon raw material in the crucible is molten;

### DETAILED DESCRIPTION

In the following specification, terms such as top, bottom, left, and right and corresponding terms refer to the figures and shall not be regarded as limiting, even though these terms refer to preferred embodiments.

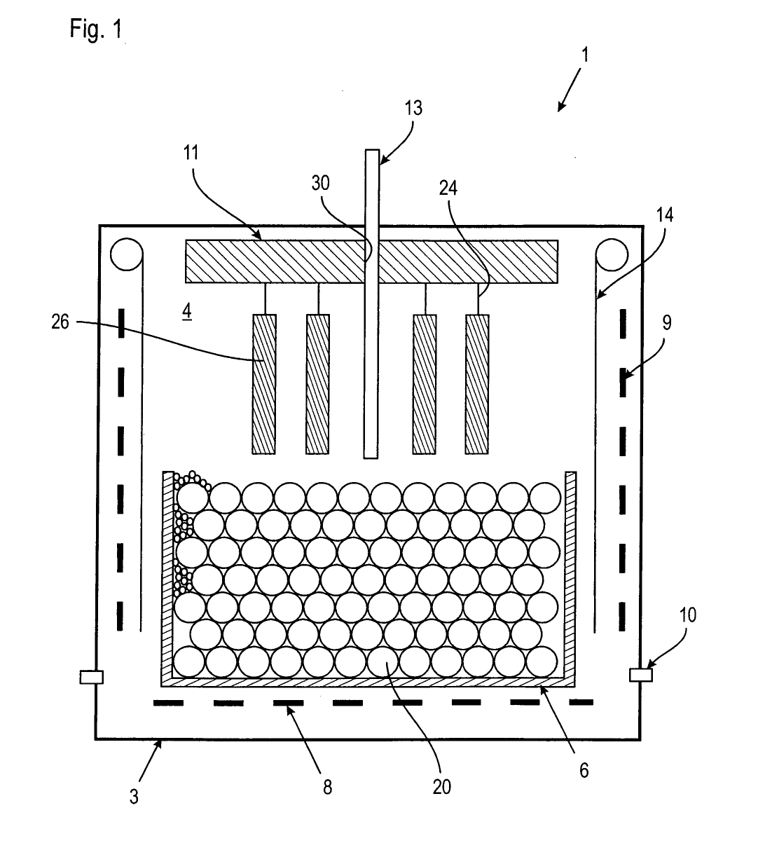

FIG. 1 shows a schematic sectional view of an apparatus 1 for producing a polycrystalline silicon ingot.

The apparatus 1 generally comprises an isolated box 3 defining a process chamber 4. In the process chamber 4, a holding unit—not shown in detail—for holding a crucible 6, a bottom heating unit 8, and lateral or side heating unit 9 are provided. At least one gas outlet 10 is provided at the lower end of the side wall of the isolated box 3. A plate element 11 is provided above the holder for the crucible 6. Furthermore, a gas feeding tube 13 is provided, the gas feeding tube 13 extends from above through the isolated box 3 and through the plate element 11 into the process chamber 4. Optional film or foil curtains 14 are provided between the side heaters 9 and the crucible 6, the foil curtains 14 being fixed above the top side heating unit.

The isolated box 3 is made of an appropriate insulating material, as is known in the art, and thus, the isolated box 3 is not described in detail. The process chamber 4 is connected to gas feeding and gas outlet tubes via means which are not shown in detail, and which allow a predetermined process atmosphere in the process chamber 4 to be adjusted. Of these means only the gas feeding tube 13 and the gas outlets 10 are shown.

The crucible 6 is made of an appropriate material such as silicon-carbide, quartz, silicon-nitride, or quartz coated with silicon-nitride, as known in the art, wherein the material does not affect the manufacturing process and is resistant to the high temperatures when melting silicon material. Usually, the crucible 6 is at least partially destroyed during the process by thermal expansion processes, and thus, the crucible 6 may be easily removed for taking out the finished silicon ingot or block from the crucible.

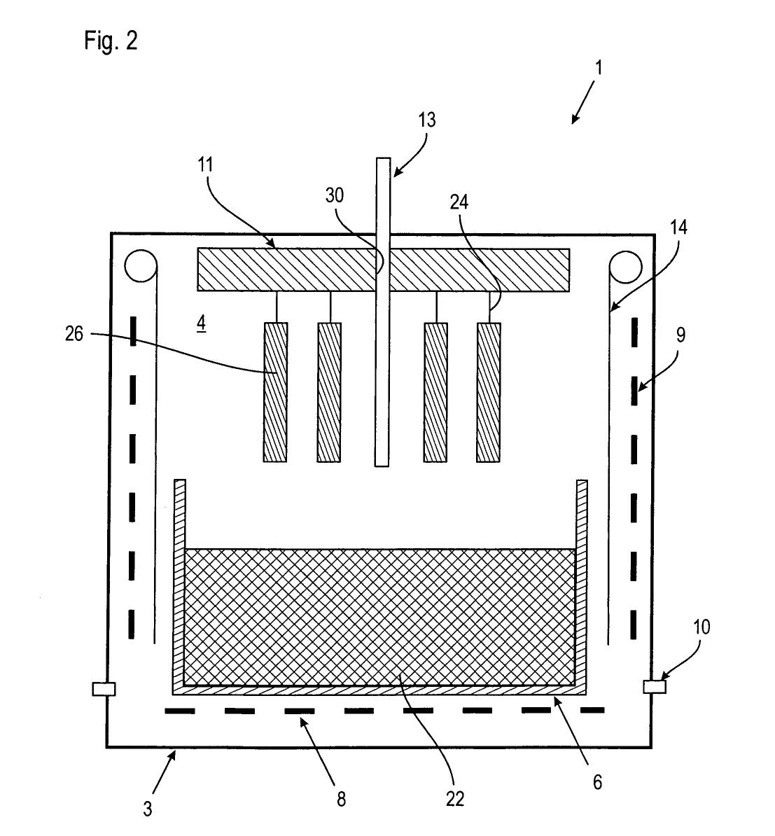

The crucible 6 forms a bowl open to the top, which may, as shown in FIG. 1, be filled with silicon raw material 20 up to the top edge. For filling the crucible, e.g. silicon rods may be used, and the space in between the rods may at least partially be filled with broken silicon material, as indicated on the left side in FIG. 1. By this means, a good degree of filling may be achieved; however some air pockets remain in the charged crucible. This results in the silicon material 20, when molten, not completely filling the crucible 6, as shown in FIG. 2, wherein the hatched region depicts molten silicon 22.

The bottom heating unit 8 and the side heating units 9 are suitable heating units capable of heating the process chamber 4 and especially the crucible 6 and the silicon raw material 20 located therein in an appropriate manner such that the raw material 20 melts and forms molten material 22, as shown in FIG. 2.

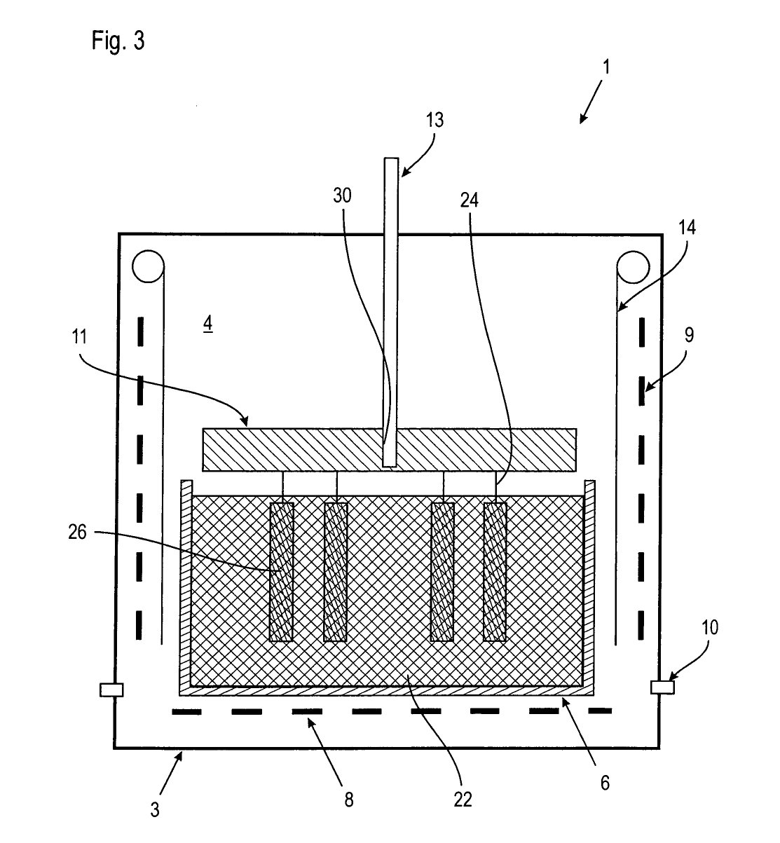

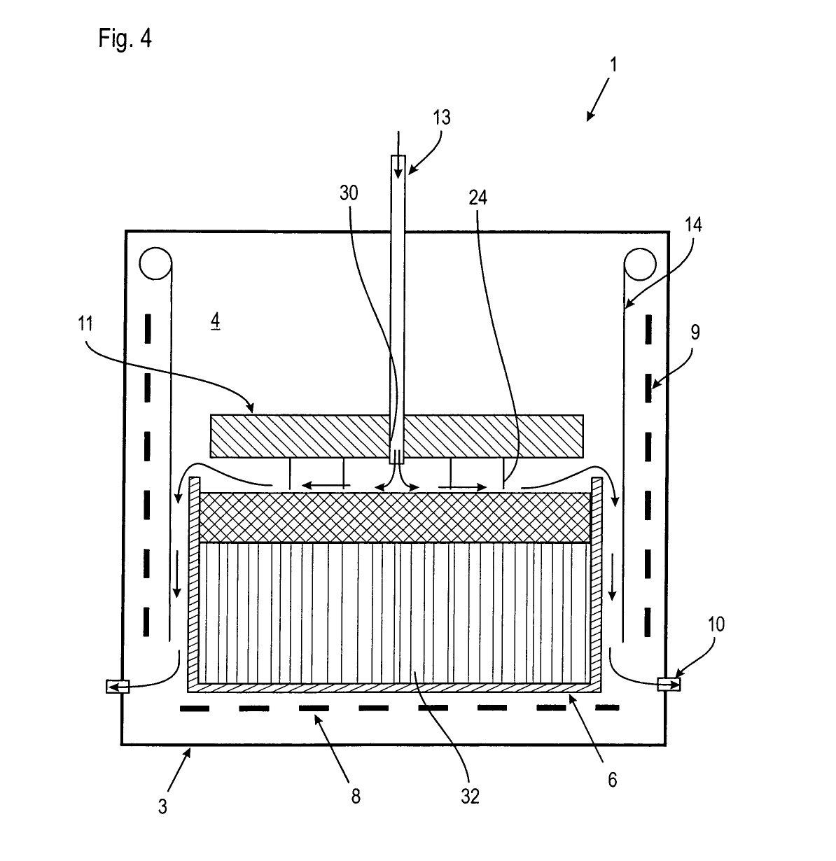

The plate element 11 located above the crucible 6 is made of appropriate material which does not melt at the temperatures used for melting the silicon raw material and which does not introduce contaminations into the process. The plate element 11 may be raised and lowered via a mechanism (not shown in detail) inside the process chamber, as will be explained in more detail with respect to FIGS. 3 and 4. At the bottom side of the plate element 11, holding units 24 are provided, which are capable of holding additional silicon raw material, such as silicon rods 26, below the plate element 11. In the arrangement according to FIG. 1, four silicon rods 26 are shown, which are located in one row below the plate element 11. Additional such holding elements are provided in the depth direction (i.e. perpendicular to the plane of the drawings) to hold additional silicon rods 26.

Furthermore, the holding elements 24 may also carry silicon raw material in the form of disks or rod sections of varying lengths. The holding elements are shown as simple rods, which are, for example, threaded into the silicon rods. The holding elements may also be grippers or other elements adapted to support the silicon rods 26. Again, the holding elements should be made from temperature-resistant material which does not contaminate the molten silicon.

The plate element 11 has a circumferential shape approximately corresponding to the inner circumference of the crucible 6. The plate element has a central passage 30 through which the gas feeding tube 13 extends.

The gas feeding tube 13 is made from an appropriate material such as graphite. The gas feeding tube 13 extends from the process chamber 4 through the isolated box 3 to the outside and is connected to an appropriate gas supply unit for supplying for example, Argon. Gas may be fed to the process chamber 4 via the gas feeding tube 13, as will be explained below in more detail. The gas feeding tube 13 may provide a guide for the plate element 11 during the raising or lowering of the plate element.

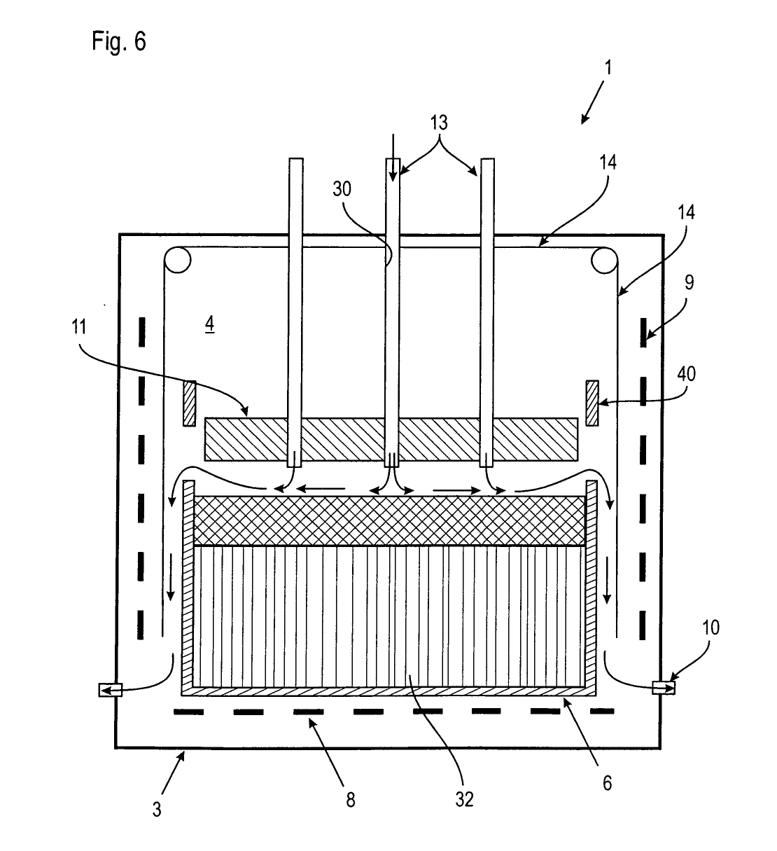

Fixing elements for foil curtains 14 are indicated above the side heating unit 9 (FIG. 1). The foil curtains 14 connected thereto may extend to a region between the side heating units 9 and the crucible 6, as shown in FIGS. 1-4. Optionally, the foil curtains may also at least partially cover the top area of the process chamber 4 (FIG. 6). The foil curtains 14 are made of temperature resistant material which is impermeable to gas.

Operation of apparatus 1 will be explained in more detail hereinbelow with respect to FIGS. 1 to 4, wherein the figures show the same apparatus during different process steps.

FIG. 1 shows the apparatus 1 prior to the actual production process. The crucible 6 is filled with silicon raw material 20 up to its upper edge. As shown, silicon rods and granulated silicon have been used for filling the crucible 6. Silicon rods 26 are fixed to the plate element 11 via the holding elements 24.

After the apparatus 1 has been prepared in such a way, the silicon raw material 20 is melted in the crucible 6 via heat input by the bottom heating unit 8, and the side heating units 9. The side heating units 9 and the bottom heating unit are controlled during this process in such a way that heat input primarily comes from below, such that the silicon rods 26 which are held above the crucible 6 via the plate element 11, will be heated but not melted.

When the silicon raw material 20 is completely melted, a silicon melt or molten silicon 22 is formed in the crucible 6, as is shown in FIG. 2. The silicon rods 26 fixed to the plate element 11 are not melted at this point in time. Thereafter, the plate element 11 is lowered via the lifting mechanism (not shown in detail) in order to immerse the silicon rods 26 into the molten silicon 22, as is shown in FIG. 3. In this way, the filling level of the molten silicon 22 in the crucible is raised substantially, as may be seen in FIG. 3. The immersed silicon rods 26 are completely melted due to the contact with the molten silicon 22, and as appropriate, due to the additional heat input provided by the bottom heater 8 and the side heaters 9 and is intermixed with the molten material 22.

In the following, the plate element may be maintained in the position according to FIG. 3 as long as the holding elements 24 do not contact the molten silicon 22. In case the holding elements contact the molten silicon, the plate element 11 will be raised slightly in order to lift the holding elements 24 from the molten material 22, as is shown in FIG. 4.

At this point in time, the heat input by the bottom heater 8 and the side heating units 9 may be reduced substantially or may be switched off in order to achieve cooling of the molten silicon 22 in the crucible 6. The cooling is controlled via appropriate means, which are not shown, in such a way that the solidification of the molten material 22 occurs from the bottom to the top in a directional manner. FIG. 4 shows the lower part 32 of the silicon material in the crucible being solidified, while molten silicon 22 still exists on top. At one point in time during the solidification and especially at the end of the solidification, a gas, such as Argon, is directed onto the surface of the molten silicon 22 via the gas feeding tube 13. The gas flows radially over the surface of the molten silicon 22 to the edge of the crucible and thereafter it flows between the crucible 6 and the foil curtain 14 to the gas outlet 10, as shown in FIG. 4. The foil curtain 14 acts as a protection for the side heating units 9 against a contact of the gas, which is directed over the surface of the molten silicon and thus comprises gaseous silicon, with the side heating units 9.

The side heating units 9 may optionally be surrounded by additional gas, which is e.g. introduced separately between the foil curtain 14 and the isolated box 3, wherein the additional gas does not chemically react with the material of the side heating units 9, or with the gas flow directed over the surface of the molten silicon (e.g. Argon or another inert gas). In this way, gas, which is directed over the molten silicon 22 and comprises gaseous silicon, is prevented from reaching the heating units. The additional gas directed over the side heating units 9 as well as the gas directed over the molten silicon 22 may be discharged via the gas outlets 10.

Once the molten silicon 22 is completely solidified, a silicon ingot is formed in the crucible 6, the silicon ingot being the final product. The ingot may be further cooled down to a handling temperature in the process chamber 4 before the ingot is removed from the process chamber 4.

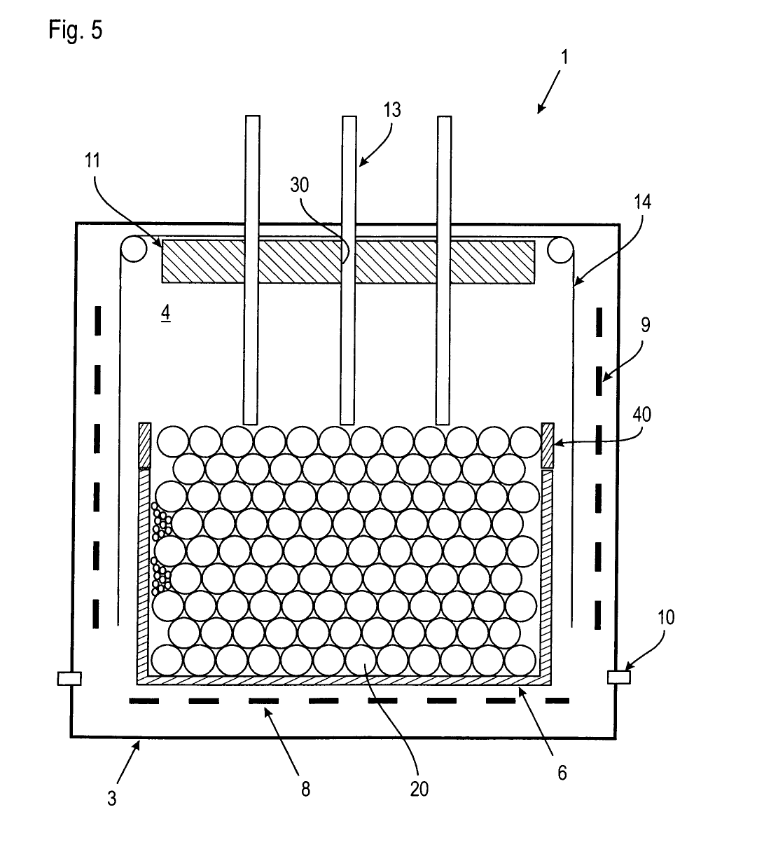

FIGS. 5 and 6 show an alternative embodiment of an apparatus 1 for producing a polycrystalline silicon ingot, according to the present invention. The same reference signs are used in FIGS. 5 and 6 inasmuch as the same or similar elements are described.

Again, the apparatus 1 consists basically of an isolated box 3, which forms an interior process chamber 4. A holder for a crucible 6 is provided in the process chamber 4. Furthermore, a bottom heating unit 8 and side heating units 9 are provided in the process chamber. Furthermore, as indicated in FIG. 6, foil curtains 14 may be provided in the process chamber 4, which may additionally extend at least partially along the ceiling area of the isolated boy. The foil curtain 14 is arranged such that it at least partially overlaps the side walls of the crucible like a canopy, such that all side heaters are outside of the overlapped area. These elements are similar to the ones of the embodiment of FIGS. 1 to 4, and thus they are not described in detail to avoid undue repetition.

Within the process chamber, a plate element 11 is provided above the crucible 6. The plate element 11 is again made of a suitable material which does not negatively influence the production of the polycrystalline silicon ingot. The plate element 11 in this embodiment (FIG. 5 and FIG. 6) does not have holders for receiving additional silicon material.

The plate element 11 comprises a plurality of passages 30 for guiding a respective plurality of gas feed tubes 13, which each extended from the process chamber 4 through the isolation box 3 to the outside. The gas feed tubes 13 may be of the same type as the gas feed tube 13 according to FIG. 1. However a larger number thereof is provided. In the representation of FIG. 5 three gas feed tubes 13 are shown across the width thereof. Correspondingly, also in the depth direction of the apparatus, three gas feed tubes 13 would be arranged in a row, such that all together nine gas feed tubes 13 are provided. Obviously, a different number of gas feed tubes 13 can be provided. Furthermore, the plate element 11 may have a further plurality of passages for passing a corresponding further plurality of gas outlet tubes (not shown) therethrough and a respective number of gas outlet tubes could be provided, through which the gas supplied to the molten silicon could be exhausted. This would have the advantage that the gas flowing over the surface of the molten silicon could immediately be exhausted upwards, without flowing along the side heaters.

Additionally, a holding ring 40 could be arranged in the process chamber 4. The holding ring 40 has an inner circumferential shape corresponding in substance to the inner circumference of the sidewalls of the crucible 6, as shown in FIG. 5. The holding ring is made of a suitable reusable material, such as silicon nitride, which does not melt during the melting process of the silicon raw material 20. Furthermore, silicon nitride is relatively robust and is not wetted by molten silicon, i.e. molten silicon contacting the holding ring 40 would flow downwards. The holding ring 40 may be moved up and down via a not shown mechanism as will be explained in more detail herein below.

Operation of the apparatus 1 will be described with reference to FIGS. 5 and 6 herein below.

The crucible 6 is loaded into process chamber 4 and is filled with silicon raw material 20, which may for example again consist of silicon rods and silicon granules, as shown in FIG. 5. Again the crucible 6 may be loaded up to its upper edge. Subsequently, the hold ring 40 is placed in its position on the edge of the crucible 6 or is held closely spaced thereto. Thereafter, additional silicon raw material for example in the shape of silicon rods may be loaded into the holding ring 40. Thus, loading of the crucible 6 is possible such that the material extends above the upper edge of the crucible 6, as show in FIG. 5. Such a loading is obviously also possible outside of the process chamber 4 and the crucible 6 and the holding ring 40 may be loaded into the process chamber 4 already filled.

Subsequently, the silicon raw material 20 in the crucible 6 as well as the additional silicon raw material in the area of the holding ring 40 is completely melted to form molten silicon 22 in the crucible 6. The total amount of material is chosen such that the molten silicon 22 may be completely received within the crucible 6. This may for example be achieved by weighing the used silicon raw material before loading the same.

At this point in time the holding ring 40 may be lifted off of the crucible 6. The plate element 11 may be lowered into a position adjacent to the molten silicon 22 in the crucible 6 as shown in FIG. 6. The foil curtains 14 may again be brought into a position between the side heater 9 and the crucible 6, as is also shown in FIG. 6. The molten silicon in the crucible 6 is a this point in time again cooled in a controlled manner in order to cause directional solidification for forming a polycrystalline silicon ingot.

FIG. 6 again shows in a lower section 32 the partially solidified silicon ingot and the still molten silicon 22 on top thereof. During at least a portion of the cooling, a gas flow, such as an Argon flow, is again directed onto the surface of the molten silicon 22 via the gas feed tube 13, as is shown in FIG. 6 by the flow arrows. Again, a controlled flow space is formed between the plate element 11 and the surface of the molten silicon. Since the holding ring 40 is lifted up, it does not negatively influence the respective gas flow.

After a complete solidification the polycrystalline silicon ingot is finished and may be cooled down within the process chamber 4 to a handling temperature before it is taken out of the process chamber 4.

The invention has been described above in detail with reference to preferred embodiments of the invention without being limited to the particular embodiments. In particular, it should be noted that elements of the different embodiments may be combined with each other or that elements may be exchanged in the different embodiments. The plate element could be combined with other recharging units and it may also be formed as a heating unit. The plate element could be used as an adjustable ceiling heater.

1. A method for producing polycrystalline silicon ingots, the process comprising the following steps:
placing a crucible in a process chamber, wherein the crucible is prefilled with solid silicon material or is filled with silicon material in the process chamber;
heating the solid silicon material in the crucible above the melting temperature of the silicon material in order to form molten silicon in the crucible;
lowering a plate element located in the process chamber and comprising at least one passage for a gas supply;
cooling the silicon material in the crucible below the solidification temperature of the molten silicon; and
directing a gas flow onto the surface of the molten silicon in the crucible during at least a time period during the time period of solidification of the molten silicon, wherein the gas flow is directed onto the surface of the molten silicon at least partially via the at least one passage in the plate element, wherein by
mounting additional solid silicon material to the plate element before heating of the silicon material in the crucible in such a way that during the lowering of the plate element at least a part of the additional silicon material is immersed into the molten silicon in the crucible and melts, whereby the filling level of the molten silicon in the crucible is raised.

2. The method according to claim 1, wherein the additional silicon material is formed of silicon rods or discs.

3. The method according to claim 1, wherein the amount of solid silicon material in the crucible and the amount of additional silicon material are matched to each other to achieve a total amount of molten silicon in the crucible.

4. An apparatus (1) for producing a polycrystalline silicon ingot comprising:
a process chamber (4) having a crucible holder for holding a crucible (6);
a plate element (11) arranged in the process chamber above the crucible holder, the plate element comprising at least one passage (30);
at least one gas feeding tube (13) extending in or through the at least one passage (30) in the plate element (11); and
at least one gas feeding unit outside the process chamber (4) for feeding a gas flow in and through the gas feeding tube (13) in a region below the plate element (11), wherein
the apparatus (1) further comprises a lifting mechanism for the plate element (11) and that the plate element (11) comprises means for mounting silicon material (26).

5. The apparatus according to claim 4, wherein a holding ring (40) which has interior dimensions corresponding to the interior dimensions of side walls of the crucible (6) and an optional lifting mechanism for the holding ring (40).

6. The apparatus according to claim 5, wherein the holding ring is made of silicon nitride or at least has a silicon nitride coating on the inner circumference thereof.

7. The apparatus according to claim 4, wherein at least one side heater (9) spaced laterally with respect to the crucible holder, at least one gas outlet (10) and at least one foil curtain (14), wherein the at least one foil curtain (14) is provided between the at least one side heater (9) and the crucible (6), in such a way that a gas flow from the at least one gas feeding tube (13) is guided towards the at least one gas outlet (10) without flowing along the at least one side heater.

8. The apparatus (1) according to claim 4, wherein the plate element (11) is formed as a heater.
